(19) United States
(12) Patent Application Publication
(10) Pub. No.: US 2025/0253097 A1
(43) Pub. Date: Aug. 7, 2025

(54) MULTILAYER CERAMIC CAPACITOR AND METHOD FOR MANUFACTURING THE SAME

(71) Applicant: TAIYO YUDEN CO., LTD., Tokyo (JP)

(72) Inventor: Maiko YAMANE, Tokyo (JP)

(73) Assignee: TAIYO YUDEN CO., LTD., Tokyo (JP)

(21) Appl. No.: 19/093,930

(22) Filed: Mar. 28, 2025

Related U.S. Application Data
(63) Continuation of application No. PCT/JP2023/032954, filed on Sep. 11, 2023.

(30) Foreign Application Priority Data
Oct. 7, 2022 (JP) 2022-162278

(51) Int. Cl. H01G 4/232; H01G 4/008; H01G 4/012; H01G 4/12; H01G 4/33

(52) U.S. Cl. CPC H01G 4/2325; H01G 4/12; H01G 4/33; H01G 4/008; H01G 4/012

(57) ABSTRACT

The multilayer ceramic capacitor pertaining to one aspect of the present invention includes: a ceramic element body that has a laminate with a roughly rectangular parallelepiped shape and comprising multiple internal electrodes facing each other in the stacking direction and a dielectric layer arranged between the multiple internal electrodes, a pair of external electrodes arranged in connection with the ends of draw-out portions of the internal electrodes on a draw-out surface of the ceramic element body where the internal electrodes are drawn out, and a ceramic layer arranged in contact with the entire circumference of the external electrodes when viewed from the draw-out surface side.

### CROSS-REFERENCE TO RELATED APPLICATIONS

This application is a bypass continuation of International Application No. PCT/JP2023/032954, filed Sep. 11, 2023, which claims the benefit of Japanese Application No. 2022-162278, filed Oct. 7, 2022, in the Japanese Patent Office. All disclosures of the documents named above are incorporated herein by reference.

### BACKGROUND OF THE INVENTION

### 1. Field of the Invention

This invention relates to a multilayer ceramic capacitor and a method for manufacturing the same, and more particularly, to a multilayer ceramic capacitor having a pair of external electrodes electrically connected to the ends of the internal electrodes that is drawn out and exposed on the draw-out surface of the ceramic element body, and a method for manufacturing the same.

### 2. Description of the Related Art

In recent years, the miniaturization and thinning of digital electronic devices such as mobile phones has led to the miniaturization and increased capacity of multilayer ceramic capacitors, which are mounted on electronic circuit boards.

A typical multilayer ceramic capacitor includes a ceramic element body with multiple internal electrodes facing each other in the stacking direction and a dielectric layer arranged between the said multiple internal electrodes, as well as external electrodes formed at both ends of the length direction of the ceramic element body.

In a multilayer ceramic capacitor with external electrodes on both ends of the length direction, the size in the length direction increases by the size of the external electrodes. In addition, in a multilayer ceramic capacitor with external electrodes on both ends of the length direction, a distance must be provided between the external and internal electrodes on the surface where the internal electrodes are not drawn out in order to provide insulation.

Therefore, it is known that space can be saved on the circuit board by arranging the external electrode on the undersurface of the multilayer ceramic capacitor so that it can be soldered to the circuit board. This undersurface-mounted multilayer ceramic capacitor can have a wider internal electrode area because it does not need to consider the insulation distance from the external electrode. For this reason, it is possible to increase the capacitance of a laminate of the same size compared to a conventional multilayer ceramic capacitor with external electrodes on both ends of the ceramic element body.

As an example of an undersurface-mounted multilayer ceramic capacitor, Patent Documents 1 and 2 describe that the first external electrode and the second external electrode are formed on the mounting surface of the ceramic element body, and an insulating layer is formed between these external electrodes. In addition, Patent Document 3 describes the formation of external electrodes in the first and second grooves on the mounting surface of the ceramic element body. Patent Document 3 states that by forming an external electrode in the groove, the problem of reduced solder joint strength caused by the reduced area of the external electrode soldered to the mounting substrate, which occurs in undersurface-mounted type multilayer ceramic capacitors, can be solved.

### PRIOR ART DOCUMENTS

### Patent Documents

Patent Document 1: JP 2013-46052 A

Patent Document 2: WO 2018/159838 A1

Patent Document 3: JP 2018-14482 A

### SUMMARY OF THE INVENTION

### Problem(s) to Be Solved by the Invention

In the undersurface-mounted type multilayer ceramic capacitors described in Patent Documents 1 to 3, at least part of the edge of the external electrode formed on the surface of the ceramic element body where the internal electrode is drawn out is exposed to the surface of the multilayer ceramic capacitor, so moisture can easily penetrate from that edge. If moisture penetrates, it will easily reach the laminate and cause a current leak, reducing the reliability of the multilayer ceramic capacitor.

In addition, the edges of the external electrodes exposed on the surface of the multilayer ceramic capacitor described above are likely to concentrate the stress that occurs at the interface between the ceramic element body and the external electrode, and microcracks may occur here, which may promote the penetration of moisture as described above.

Furthermore, in a structure with a pair of external electrodes only on the undersurface, the area where the internal electrodes are drawn out to the outside of the ceramic element body is narrower than in the external electrode structure of conventional multilayer ceramic capacitors, which have external electrodes on the opposite surfaces. As a result, the contact area between the internal and external electrodes becomes smaller, increasing the likelihood of poor contact. Furthermore, the two external electrodes must be sufficiently separated within the same plane so that they do not conduct.

This invention was made in view of the above problems with the prior art, and aims to provide an external electrode structure that improves reliability of multilayer ceramic capacitor by preventing moisture from entering from the ends of the external electrodes and preventing cracks from occurring due to stress being concentrated at the ends of the external electrodes, in a multilayer ceramic capacitor in which a pair of external electrodes are formed on one side of a ceramic element body where the internal electrodes have been drawn out. This invention also aims to provide a manufacturing method of the external electrode structure.

### Means for Solving the Problems

The present inventor, as a result of research conducted to solve the aforementioned problem, conceived the idea of arranging a ceramic layer on the surface of a ceramic element body in which internal electrodes are drawn out and a pair of external electrodes are formed, so that the ceramic layer contacts the entire circumference of each of the external electrodes when viewed from the surface on which the internal electrodes are drawn out. By arranging the ceramic layer, it was found that the penetration of moisture from the edges of the external electrodes could be prevented, and that cracks originating from the edges of the external electrodes could be prevented by dispersing the stress that occurs at the interface between the ceramic element body and the external electrode, which is concentrated at the edges of the external electrode, to the surrounding ceramic layer, and this led to the completion of the present invention.

Specifically, one aspect of the present invention for solving the aforementioned problem is a multilayer ceramic capacitor comprising:
a ceramic element body that has a laminate with a roughly rectangular parallelepiped shape and comprising multiple internal electrodes facing each other in the stacking direction and a dielectric layer arranged between the multiple internal electrodes,
a pair of external electrodes arranged in connection with the ends of draw-out portions of the internal electrodes on a draw-out surface of the ceramic element body where the internal electrodes are drawn out, and
a ceramic layer arranged in contact with the entire circumference of the external electrodes when viewed from the draw-out surface side.

Another aspect of the present invention for solving the aforementioned problem is a method for manufacturing a multilayer ceramic capacitor comprising:

(A) laminating a predetermined number of ceramic green sheets with internal electrode patterns, which have a main body pattern and a drawer pattern that extends in one direction from the main body pattern, so that the main body pattern overlaps all layers and the drawer pattern overlaps every other layer when viewed from the stacking direction, and then laminating a ceramic green sheet without an internal electrode pattern to the top and/or bottom surface of the stacking direction, covering the internal electrode pattern,
(B) pressing the ceramic green sheets together to make a laminated sheet,
(C) cutting the laminated sheet to the predetermined dimensions to obtain a green laminated chip with a draw-out surface that exposes all of the edges of the drawer pattern,
(D) by performing one of following operations (D-1) to (D-3), forming a pair of base electrodes that are electrically connected every other layer at the end of the drawer pattern exposed on the draw-out surface and a ceramic layer arranged to be in contact with entire circumference of the base electrodes when viewed from the draw-out surface side of the resulting green laminated chip,
(D-1) preparing a ceramic green sheet having an opening filled with nickel-containing paste whose shape corresponds to the planar shape of the base electrode in planar view and penetrates in the thickness direction, punching out the ceramic green sheet at the draw-out surface of the green laminated chip, and attaching the ceramic green sheet to the draw-out surface, and then firing,
(D-2) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface, filling nickel-containing paste into the opening, and then firing,
(D-3) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface, firing the green laminated chip, and then filling copper-containing paste into the opening and baking, and
   (E) forming a plating layer on the base electrode.

Another aspect of the present invention for solving the aforementioned problem is a method for manufacturing a multilayer ceramic capacitor comprising:

(A) laminating a predetermined number of ceramic green sheets with internal electrode patterns, which have a main body pattern and a drawer pattern that extends in one direction from the main body pattern, so that the main body pattern overlaps all layers and the drawer pattern overlaps every other layer when viewed from the stacking direction, and then laminating a ceramic green sheet without an internal electrode pattern to the top and/or bottom surface of the stacking direction, covering the internal electrode pattern,
(B) pressing the ceramic green sheets together to make a laminated sheet,
(C) cutting the laminated sheet to the predetermined dimensions to obtain a green laminated chip with a draw-out surface that exposes all of the edges of the drawer pattern,
(D)′ by performing following operations (D-4) and (D-5), forming a pair of nickel base layers that are electrically connected to every other layer at the end of the drawer pattern exposed on the draw-out surface, a pair of base electrodes that are electrically connected to the nickel base layers, and a ceramic layer arranged to be in contact with entire circumference of the base electrodes when viewed from the draw-out surface side of the resulting green laminated chip,
(D-4) by performing one of following operations (D-4-1) to (D-4-3), forming a pair of nickel-containing layers that will become the nickel base layers after firing on the draw-out surface where the edges of the internal electrode patterns are exposed, so that they cover the exposed edges of the internal electrode patterns,
   (D-4-1) preparing a ceramic green sheet that alternately has a plurality of nickel-containing areas corresponding to the planar shape of the nickel base layer formed with a nickel-containing paste and a plurality of ceramic green sheet areas, punching out the ceramic green sheet at the draw-out surface of the green laminated chip, and attaching the ceramic green sheet to each end surface,
   (D-4-2) preparing a ceramic green sheet having an opening with a shape corresponding to the planar shape of the nickel base layer in planar view and penetrating in the thickness direction, punching out the ceramic green sheet at the draw-out surface of the green laminated chip, and after the ceramic green sheet being attached to the draw-out surface, filling nickel-containing paste into the opening to form a nickel-containing layer,
   (D-4-3) forming nickel-containing layers by sputtering deposition, vapor deposition, or printing,
(D-5) by performing one of the following operations (C-5-1) to (C-5-3), forming a pair of base electrodes in all, a part of, or multiple areas of each nickel-containing layer,
   (D-5-1) preparing a ceramic green sheet having an opening filled with nickel-containing paste whose shape corresponding to the planar shape of the base electrode in planar view and penetrates in the thickness direction, punching out the ceramic green sheet at the draw-out surface of the green laminated chip, and attaching the ceramic green sheet to the draw-out surface where the nickel-containing layers have formed, and then firing,
   (D-5-2) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface where the nickel-containing layers have formed, filling nickel-containing paste into the opening, and then firing,
   (D-5-3) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface where the nickel-containing layers have formed, firing the green laminated chip, and then filling copper-containing paste into the opening and baking, and
      (E) forming a plating layer on the base electrode.

### Effect of the Invention

According to this invention, it is possible to prevent moisture from entering from the edges of the external electrodes. This is because a ceramic layer is arranged to be in contact with entire circumference of the external electrode placed on the draw-out surface, as seen from the side of the internal electrode draw-out surface of the ceramic element body. In addition, the stress that occurs at the interface between the ceramic element body and the external electrode at the end of the external electrode can be dispersed to the ceramic layer around the external electrode, so microcracks caused by stress can be prevented.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic perspective view showing an example of a multilayer ceramic capacitor related to one aspect of the present invention.

FIG. 2 is a perspective view of the example of the multilayer ceramic capacitor shown in FIG. 1, with the external electrodes removed.

FIG. 3 is a cross-sectional view along the a-a line in FIG. 1, showing the arrangement of the ceramic element body and external electrodes in the example of the multilayer ceramic capacitor shown in FIG. 1.

FIG. 4A is a cross-sectional view along the b₁-b₁ line in FIG. 1, showing the connection between the internal and external electrodes in the example of the multilayer ceramic capacitor shown in FIG. 1.

FIG. 4B is a cross-sectional view along the b₂-b₂ line in FIG. 1, showing the connection between the internal and external electrodes in the example of the multilayer ceramic capacitor shown in FIG. 1.

FIG. 5 is a cross-sectional view in the same direction as FIG. 3, showing an example of the surface shape of the external electrode in a multilayer ceramic capacitor related to one aspect of the present invention.

FIG. 6 is a cross-sectional view in the same direction as FIG. 3, showing another example of the surface shape of the external electrode in a multilayer ceramic capacitor related to one aspect of the present invention.

FIG. 7 is a cross-sectional view in the same direction as FIG. 3, schematically showing the external electrode structure of the first embodiment.

FIG. 8 is a partial enlarged cross-sectional view of the external electrode structure shown schematically in FIG. 7, in the same direction as FIG. 4A and FIG. 4B.

FIG. 9 is a cross-sectional view in the same direction as FIG. 3, schematically showing the external electrode structure of the second embodiment.

FIG. 10 is a partial enlarged cross-sectional view of the external electrode structure shown in FIG. 9, in the same direction as FIG. 4A and FIG. 4B.

FIG. 11A is a schematic view showing an example of the arrangement of the base electrode in the external electrode structure of the second embodiment, and shows the ceramic element body with the base electrode and ceramic layer arranged, as seen from the side of the internal electrode draw-out surface.

FIG. 11B is a schematic view showing another example of the arrangement of the base electrode in the external electrode structure of the second embodiment, and shows the ceramic element body with the base electrode and ceramic layer arranged, as seen from the side of the internal electrode draw-out surface.

FIG. 11C is a schematic view showing another example of the arrangement of the base electrode in the external electrode structure of the second embodiment, and shows the ceramic element body with the base electrode and ceramic layer arranged, as seen from the side of the internal electrode draw-out surface.

FIG. 11D is a schematic view showing another example of the arrangement of the base electrode in the external electrode structure of the second embodiment, and shows the ceramic element body with the base electrode and ceramic layer arranged, as seen from the side of the internal electrode draw-out surface.

FIG. 11E is a schematic view showing another example of the arrangement of the base electrode in the external electrode structure of the second embodiment, and shows the ceramic element body with the base electrode and ceramic layer arranged, as seen from the side of the internal electrode draw-out surface.

FIG. 12 is a schematic view showing an example of a method for forming a base electrode and a ceramic layer arranged in contact with entire circumference of the base electrode on the draw-out surface of the internal electrode of a green laminated chip by the operation (D-1), in a method for manufacturing a multilayer ceramic capacitor related to another aspect of the present invention.

FIG. 13 is a schematic view showing an example of a method for forming a base electrode and a ceramic layer arranged in contact with entire circumference of the base electrode on the draw-out surface of the internal electrode of a green laminated chip by the operation (D-2) or (D-3), in a method for manufacturing a multilayer ceramic capacitor related to another aspect of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The following is an explanation of the embodiment for implementing the present invention with reference to the drawings, but the present invention is not limited to the embodiment and includes various other embodiments within the scope of the technical ideas described in the claims.

When using “to” to indicate a range of values, it also includes the values listed as the lower and upper limits.

### Multilayer Ceramic Capacitor

A multilayer ceramic capacitor pertaining to one aspect of the present invention (hereinafter referred to as “a multilayer ceramic capacitor related to the first aspect”) has a ceramic element body that has a laminate with a roughly rectangular parallelepiped shape and comprising multiple internal electrodes facing each other in the stacking direction and a dielectric layer arranged between the multiple internal electrodes, a pair of external electrodes that are arranged in connection with the ends of draw-out portions of the internal electrodes on a draw-out surface of the ceramic element body where the internal electrodes are drawn out, and a ceramic layer arranged in contact with the entire circumference of the external electrodes when viewed from the draw-out surface side.

The term “roughly rectangular parallelepiped shape” includes shapes with rounded edges or corners, or curved edges, and refers to a shape that is roughly rectangular.

The dimensions of the multilayer ceramic capacitor are not limited, but for example, the length (L) is 0.6±0.1 mm, the width (W) is 0.3±0.08 mm, and the height (T) is 0.3±0.08 mm.

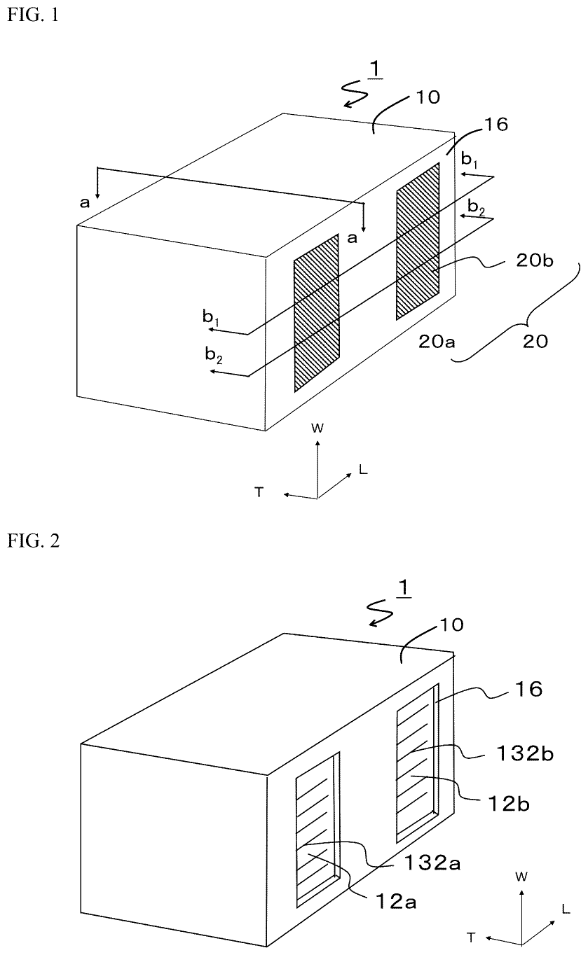

FIG. 1 shows a schematic perspective view of an example of a multilayer ceramic capacitor related to the first aspect, and FIG. 2 shows a perspective view of the same capacitor with the external electrodes removed.

In the FIG. 1 is a multilayer ceramic capacitor, 10 is a ceramic element body, 16 is a ceramic layer, 20 is an external electrode, 20a and 20b are the first and second external electrodes respectively, and 132a and 132b are the first and second draw-out portions of internal electrodes, respectively.

As shown in FIG. 1 and FIG. 2, the multilayer ceramic capacitor 1 related to the first aspect has a pair of first external electrodes 20a and second external electrodes 20b with different polarities arranged on the draw-out surface of the internal electrodes of the ceramic element body 10.

The first external electrode 20a and the second external electrode 20b are arranged so that the first external electrode 20a is electrically connected to the ends of the first draw-out portion 132a of the internal electrodes, and the second external electrode 20b is electrically connected to the ends of the second draw-out portion 132b of the internal electrodes, on the draw-out surface where the ends of the first draw-out portion 132a and the ends of the second draw-out portion 132b are drawn out and exposed.

The ceramic layer 16 is arranged in contact with the entire circumference of the first external electrode 20a and the second external electrode 20b when viewed from the draw-out surface side.

The relative positions of the first external electrode 20a and the second external electrode 20b with respect to the ceramic layer 16 can also be explained as being such that the first and second external electrodes 20a and 20b are arranged within a pair of openings in the ceramic layer 16, through which the ends of the first draw-out portion 132a and second draw-out portion 132b of the internal electrodes are drawn out and exposed.

The following is a specific explanation of the structure of the ceramic element body 10, the electrical connection between the ceramic element body 10 and the external electrode 20, and the structure of the external electrode 20, in an example of a multilayer ceramic capacitor 1 related to the first aspect, as illustrated in FIG. 1 and FIG. 2.

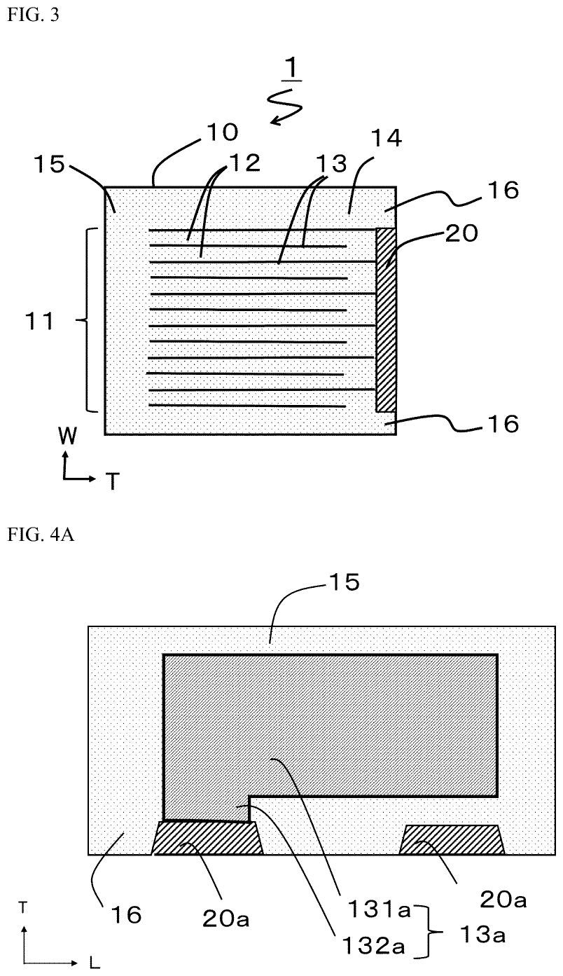

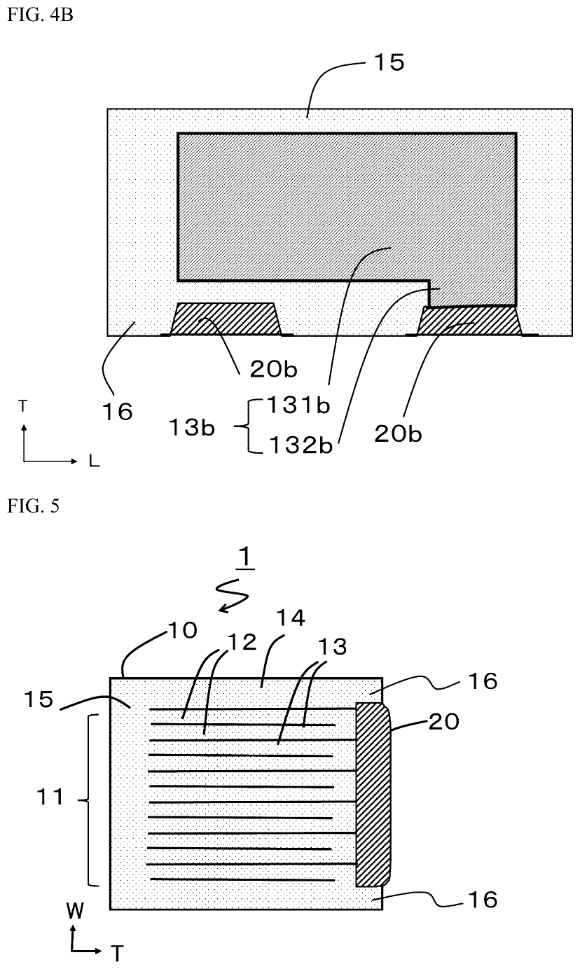

FIG. 3, FIG. 4A and FIG. 4B show a schematic view of the structure of the ceramic element body 10 and the external electrode 20, as well as the connection state of the internal electrodes and the external electrode 20, in the multilayer ceramic capacitor illustrated in the FIG. 1, respectively.

FIG. 3 is a cross-sectional view along the a-a line in the FIG. 1, FIG. 4A is a cross-sectional view along the b₁-b₁ line in the FIG. 1, and FIG. 4B is a cross-sectional view along the b₂-b₂ line in the above-mentioned FIG. 1.

In FIG. 3, FIG. 4A and FIG. 4B, 1 is a multilayer ceramic capacitor, 10 is a ceramic element body, 11 is a laminate, 12 is a dielectric layer, 13 is an internal electrode, 13a and 13b are the first and the second internal electrodes, respectively, 131a and 131b are the main body portions of the first internal electrode 13a and the second internal electrode 13b, respectively, 132a and 132b are the draw-out portions of the first internal electrode 13a and the second internal electrode 13b, respectively, 14 and 15 are protective portions, 16 is a ceramic layer, 20 is an external electrode, and 20a and 20b are the first external electrode and the second external electrode, respectively.

As shown in FIG. 3, the ceramic element body 10 has a laminate 11 with a roughly rectangular parallelepiped shape and comprising multiple internal electrodes 13 facing each other in the stacking direction and a dielectric layer 12 arranged between the multiple internal electrodes. On one surface parallel to the stacking direction of the laminate 11, the draw-out portions 132a and 132b of the internal electrodes 13 are alternately drawn out and exposed at specified intervals every other layer.

In the ceramic element body 10, protective portions 14 and 15 are formed on the top and bottom surfaces in the stacking direction of the laminate 11, and on the surfaces parallel to the stacking direction of the laminate 11, excluding the draw-out surface of the internal electrodes.

### Dielectric Layer

The dielectric layer 12 in the laminate 11 is composed of dielectric ceramics obtained by firing ceramic raw material powder.

Dielectric ceramics with high dielectric constant are used to increase the capacitance of the dielectric layer. Examples of high-dielectric-constant ceramics include materials with a perovskite structure containing barium (Ba) and titanium (Ti), such as barium titanate (BaTiO₃).

The dielectric layer 12 may include strontium titanate (SrTiO₃), calcium titanate (CaTiO₃), magnesium titanate (MgTiO₃), calcium zirconate (CaZrO₃), calcium titanate zirconate (Ca(Ti, Zr)O₃), calcium barium titanate zirconate ((Ba, Ca)(Zr, Ti)O₃), barium zirconate (BaZrO₃), titanium oxide (TiO₂), etc.

In addition, the dielectric layer 12 may include glass phases other than dielectric ceramics.

The thickness of the dielectric layer 12 after firing is preferably 1.0 μm or less, 0.5 μm or less is more preferable, and 0.3 μm or less is even more preferable. By reducing the thickness of the dielectric layer 12, the number of layers of the dielectric layer 12 can be increased, and thus the capacitance of the multilayer ceramic capacitor 1 can be increased without increasing the dimensions of the multilayer structure.

### Internal Electrode

In the multilayer ceramic capacitor 1, the first internal electrodes 13a and the second internal electrodes 13b are alternately laminated via the dielectric layer 12.

As shown in FIG. 4A and FIG. 4B, the first internal electrode 13a and the second internal electrode 13b each have a first main body portion 131a and a second main body portion 131b that overlap each other in the stacking direction, and a first draw-out portion 132a and a second draw-out portion 132b that extend in one direction from the first main body portion 131a and the second main body portion 131b, respectively.

The edges of the first and second draw-out portions 132a and 132b are alternately drawn out and exposed at specified intervals on alternate layers in a single plane parallel to the stacking direction of the laminate 11, so that they are electrically connected to the first external electrode 20a and second external electrode 20b formed on the draw-out surface of the ceramic element body 10.

The thickness of the internal electrode 13 is not particularly limited, but is usually around 0.26 μm to 1.00 μm.

In multilayer ceramic capacitors 1, there are no particular limitations on the conductive materials used to form the internal electrodes 13, and at least one metal material selected from the group consisting of nickel (Ni), copper (Cu), palladium (Pd), platinum (Pt), silver (Ag), and gold (Au) is used. Among these, it is preferable to use a metal material such as Ni or Cu as the main component, as this can help to keep manufacturing costs low even when the number of layers increases. In particular, Ni is more preferable because it can be sintered at the same time as the dielectric layer 12. When Ni is the main component of the metal material, tin (Sn) or gold (Au) may be added.

### Protective Portion

Protective portions 14 and 15 are provided to protect the dielectric layers 12 and the internal electrodes 13 from moisture and contamination from the outside, and to suppress their deterioration over time.

The thickness of the protective portions 14 and 15 is not particularly limited, but is usually 5 μm to 75 μm.

The materials used for the protective portions 14 and 15 are not particularly limited, but it is preferable that they be ceramic materials in terms of their adhesiveness to the laminate 11 and their electrical insulation properties, and it is more preferable that they be the same as the main component of the dielectric ceramics that make up the dielectric layer 12.

### Ceramic Layer

In the multilayer ceramic capacitor 1, a ceramic layer 16 is arranged on the draw-out surface of the ceramic element body 10, in contact with the entire circumference of the external electrodes 20a and 20b when viewed from the draw-out surface side. Since the ceramic layer 16 is arranged in contact with the entire circumference of the external electrode 20, (i) moisture is less likely to penetrate from the edge of the external electrode, (ii) the laminate 11, which is the capacitance-forming part, can be protected from external impacts, and (iii) stress that concentrates at the ends of the external electrodes 20a and 20b can be dispersed. In addition, (iv) the ceramic layer 16 is arranged across each layer that forms the laminate 11, so it is possible to prevent delamination.

The thickness of the ceramic layer 16 is not particularly limited, but it is preferable to be in the range of 1 μm to 40 μm, and more preferable to be in the range of 3 μm to 10 μm. By setting the lower limit to 1 μm or 3 μm or more, insulation from the outside can be maintained. In addition, by setting the upper limit to 40 μm or 10 μm or less, the height of the components during mounting can be reduced, and the equivalent series inductance (ESL) can be reduced.

In this embodiment, the material of the ceramic layer 16 is not particularly limited, but it is preferable to be a ceramic material in terms of adhesion to the laminate 11 and electrical insulation, and it is more preferable to be the same as the main component of the dielectric ceramics that makes up the dielectric layer 12.

### External Electrode

In this embodiment, a pair of external electrodes 20a and 20b are arranged on the draw-out surface of the ceramic element body 10, and are electrically connected to the ends of the draw-out portions 132a and 132b of the internal electrodes 13 that are drawn out and exposed alternately on the draw-out surface.

The external electrodes 20 (20a, 20b) do not have to be flush with the ceramic layer 16, provided that the entire circumference of the external electrodes 20 is in contact with the ceramic layer 16 when viewed from the draw-out surface side.

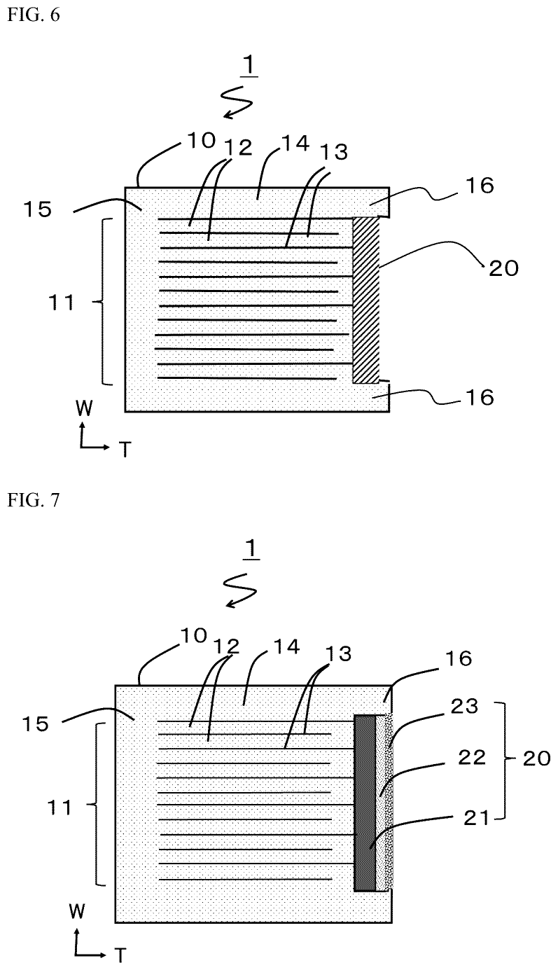

FIG. 5 and FIG. 6 show examples where the surface of the external electrode 20 (20a, 20b) is not flush with the ceramic layer 16, and are cross-sectional views from the same direction as the FIG. 3.

FIG. 5 shows a configuration in which the surface of the external electrode 20 is convexly raised with respect to the surface of the ceramic layer 16. In this case, ensuring contact with the solder during mounting can help avoid producing defective products that are not soldered. FIG. 6 shows a configuration in which the surface of the external electrode 20 is recessed relative to the surface of the ceramic layer 16. In this case, the excess solder can be absorbed by the concave part when mounting on the circuit board by soldering.

### External Electrode Configuration

In the multilayer ceramic capacitor 1 related to the first aspect, it is preferable that the external electrodes 20 (20a, 20b) have a structure in which a plating layer is formed on a base electrode.

The plating layer may be composed of multiple layers, and in this case, it is preferable to have a two-layer structure with a Sn (tin) plating layer formed on top of a Ni (nickel) plating layer.

The following describes the preferred external electrode structure for multilayer ceramic capacitors 1 related to the first aspect as first and second embodiments.

### First Embodiment

The external electrode structure of the first embodiment has an external electrode configuration that includes a base electrode that is electrically connected to the ends of the draw-out portions of the multiple internal electrodes, and a plating layer formed on the surface of the base electrode.

FIG. 7 is a cross-sectional view of the external electrode structure of the first embodiment, as seen from the same direction as FIG. 3, and FIG. 8 is a partial enlarged cross-sectional view of the same direction as FIG. 4A and FIG. 4B.

In the external electrode structure shown in FIG. 7 and FIG. 8, the external electrode 20 arranged on the draw-out surface of the ceramic element body 10 has a base electrode 21 that is electrically connected to the draw-out portions 132 of the multiple internal electrodes 13 drawn out on the draw-out surface. A nickel plating layer 22 and a tin plating layer 23 are formed on the base electrode 21 in this order.

The base electrode 21 can be made from a conductive material such as nickel (Ni), copper (Cu), palladium (Pd), platinum (Pt), silver (Ag), or gold (Au), but in terms of cost, nickel or copper is preferred. Among these, it is preferable to use a sintered metal layer, and specifically, one formed by baking a conductive paste containing various metals.

Conductive paste is made by mixing metal powder with glass components, organic binders, and organic solvents.

When using Ni for the sintered metal layer that forms the base electrode 21, the base electrode 21 and the ceramic layer 16 can be formed simultaneously.

On the other hand, if a sintered metal layer with a low melting point such as Cu is used to form the base electrode 21, it will melt at the sintering temperature of the ceramic layer 16, so it is not possible to form the base electrode 21 and the ceramic layer 16 at the same time. For this reason, as described below, the base electrode 21 is formed after the ceramic layer 16 is formed by firing.

From the perspective of relieving the stress that the external electrode 20 exerts on the ceramic element body 10, the base electrode 21 is preferably a sintered metal layer of Cu, which has a lower hardness than Ni.

In the first embodiment, the thickness of the base electrode 21 is preferably in the range of 1 μm to 35 μm.

### Second Embodiment

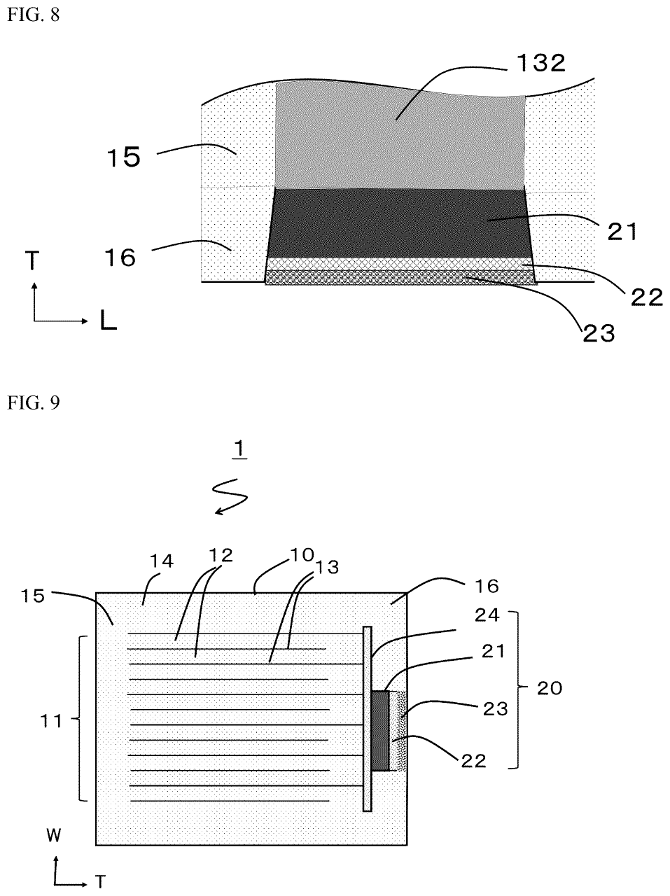

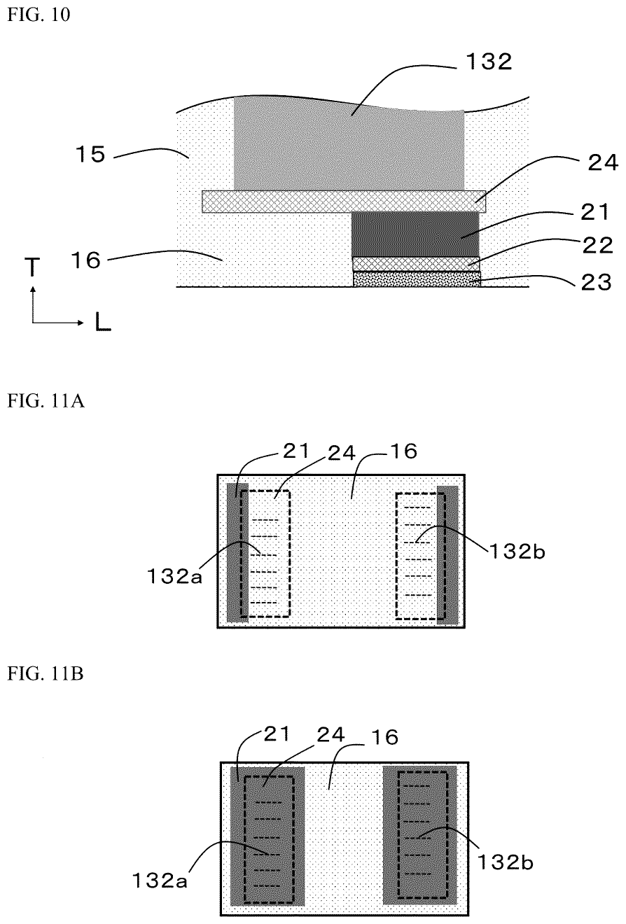

FIG. 9 is a cross-sectional view of the external electrode structure of the second embodiment, seen from the same direction as FIG. 3, and FIG. 10 is a partial enlarged cross-sectional view, seen from the same direction as FIG. 4A and FIG. 4B.

In the external electrode structure shown in FIG. 9 and FIG. 10, the external electrode 20 arranged on the draw-out surface of the ceramic element body 10 has a nickel base layer 24 between the draw-out surface of the ceramic element body 10 and the base electrode 21.

The nickel base layer 24 is formed at the position where the internal electrodes 13 are drawn out, and is connected to the ends of the drawing-out portions 132 of the multiple internal electrodes 13.

The base electrode 21 is formed on the nickel base layer 24 so as to be connected to the nickel base layer 24, and the nickel plating layer 22 and the tin plating layer 23 are formed in this order on the surface of the base electrode 21 opposite to the surface in contact with the nickel base layer 24.

The ceramic layer 16 is arranged in contact with the entire circumference of the nickel base layer 24, base electrode 21, nickel plating layer 22 and tin plating layer 23.

In the second embodiment, the electrical connection with the multiple internal electrodes 13 can be achieved by the nickel base layer 24, so the base electrode 21 only needs to be in contact with and electrically connected to a part of the nickel base layer 24. This increases the degree of freedom in the arrangement and shape of the base electrode 21. That is, the base electrode 21 may be formed so as to be in contact with the entire area where the nickel base layer 24 is formed, or it may be formed so as to be in contact with a part or multiple parts of the area where the nickel base layer 24 is formed.

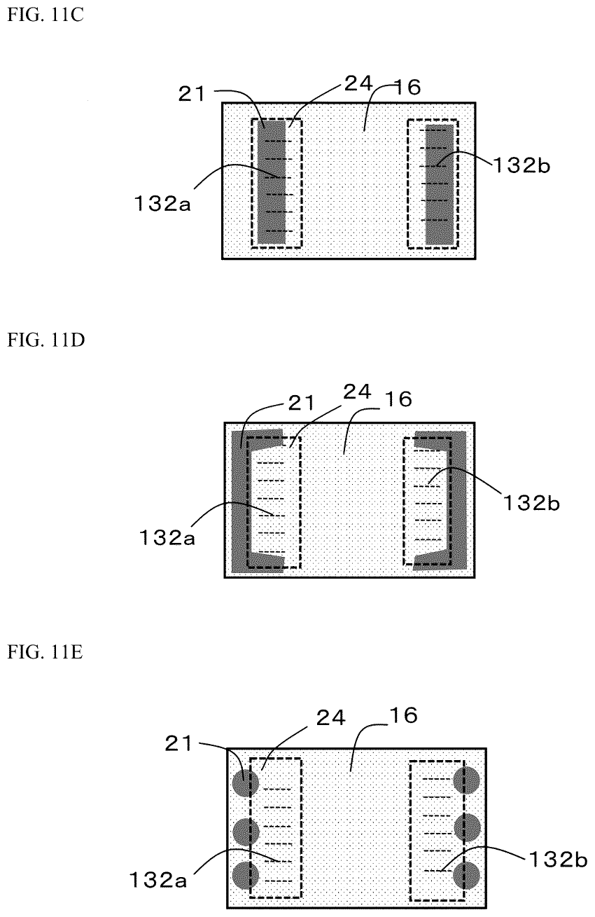

FIG. 11A, FIG. 11B, FIG. 11C, FIG. 11D and 11E are schematic views showing examples of the arrangement of the base electrode 21 in the external electrode structure of the second embodiment, and show the ceramic element body 10 after the base electrode 21 and ceramic layer 16 have been formed on the nickel base layer 24, as seen from the side of the internal electrode draw-out surface.

In all of the arrangement examples, the base electrode 21 is electrically connected to at least a portion of the area of the nickel base layer 24, and when viewed from the draw-out surface side, the base electrode 21 is surrounded on all circumferences by the ceramic layer 16.

In the example in FIG. 11A, when viewed from the draw-out surface side of the ceramic element body 10, the base electrode 21 does not overlap with the area where the internal electrode 13 is drawn out. In this case, the exposed portions of the outer electrode pair are formed with an area sufficient for mounting at the position where they are farthest apart, so that conduction between the outer electrodes can be suppressed during soldering.

In the example in FIG. 11B, when viewed from the draw-out surface side of the ceramic element body 10, the base electrode 21 is formed to cover the area where the internal electrode 13 is drawn out. In this example, the equivalent series inductance (ESL) and equivalent series resistance (ESR) can be suppressed because the conductive path is shortened.

In the example in FIG. 11C, when viewed from the draw-out surface side of the ceramic element body 10, the base electrode 21 overlaps with part of the area where the internal electrode 13 is drawn out.

In this case, the conductive path is shorter than in the example shown in FIG. 11A above, so ESL and ESR can be suppressed. In addition, the exposed positions of the external electrode pair are more separated in the area where the internal electrode 13 is drawn out, so that conduction between the external electrodes can be suppressed during soldering.

The example in FIG. 11D is a combination of the example in FIG. 11A and the example in FIG. 11C. When viewed from the draw-out surface side of the ceramic element body 10, the base electrode 21 partially overlaps the area where the internal electrodes 13 are drawn out, and the exposed portions of the external electrode pair are formed so that they are close together at both ends in the width direction and further apart in the center of the width direction. When mounting electronic components on circuit boards, the conduction caused by solder overflow usually tends to occur in the center of the width of the electronic component, but in this example, the external electrodes are separated in the center, so the conduction between the external electrodes due to the soldering can be suppressed.

In the example shown in FIG. 11E, when viewed from the draw-out surface side of the ceramic element body 10, the base electrode 21 is formed in multiple areas, and stress concentration can be reduced by dispersing the stress applied to the ceramic element body 10 from the external electrodes. At this time, the base electrode 21 may overlap with the area where the internal electrode 13 is drawn out, or it may not overlap.

It is preferable to use a sintered metal layer of Ni or Cu, etc. for the base electrode 21, in the same way as the external electrode structure of the first embodiment. When using Ni as the conductive material to form the base electrode 21, the nickel base layer 24 can be formed at the same time as the base electrode 21 and the ceramic layer 16. On the other hand, when using Cu as the conductive material, the nickel base layer 24 cannot be formed at the same time as the base electrode 21 and ceramic layer 16. For this reason, as described below, the base electrode 21 is formed after the ceramic layer 16 is formed by firing.

The base electrode 21 is preferably a sintered metal layer of Cu from the viewpoint of the stress that the external electrode exerts on the ceramic element body 10.

In the external electrode structure of the second embodiment, the ends of the draw-out portions (132a, 132b) of the internal electrodes 13 is connected to the nickel base layer 24, and from there it is connected to the base electrode 21, nickel plating layer 22 and tin plating layer 23. For this reason, the nickel base layer 24 can be made thinner than the base electrode 21 of the external electrode structure of the first embodiment described above, and it can also be made thinner than the base electrode 21 of the external electrode structure of the second embodiment. The nickel base layer 24 is preferably a nickel thin film formed by a printing method, sputtering deposition method, vapor deposition method, etc.

In the second embodiment, the thickness of the nickel base layer 24 is preferably in the range of 0.1 μm to 15 μm.

### Method for Manufacturing a Multilayer Ceramic Capacitor

A method for manufacturing a multilayer ceramic capacitor pertaining to another aspect of the present invention (hereinafter referred to as “a method for manufacturing a multilayer ceramic capacitor related to the second aspect”) includes:
laminating a predetermined number of ceramic green sheets with internal electrode patterns, which have a main body pattern and a drawer pattern that extends in one direction from the main body pattern, so that the main body pattern overlaps all layers and the drawer pattern overlaps every other layer when viewed from the stacking direction, and then laminating a ceramic green sheet without an internal electrode pattern to the top and/or bottom surface of the stacking direction, covering the internal electrode pattern,
pressing the ceramic green sheets together to make a laminated sheet,
cutting the laminated sheet to the predetermined dimensions to obtain a green laminated chip with a draw-out surface that exposes all of the edges of the drawer pattern, and
forming a pair of external electrodes that are electrically connected every other layer at the end of the drawer pattern exposed on the draw-out surface and a ceramic layer arranged to be in contact with entire circumference of the external electrodes when viewed from the draw-out surface on the draw-out surface of the resulting green laminated chip.

### Manufacturing a Green Laminated Chip

### Manufacturing Ceramic Green Sheet

Ceramic green sheets are manufactured by adding a binder and solvent to ceramic raw material powder, mixing them in a ball mill to produce a slurry, and then applying and drying the slurry to the surface of a base sheet such as plastic film using a coating machine such as a doctor blade or die coater.

### Forming Internal Electrode Patterns

There are no limitations on the method of forming the internal electrode patterns on the obtained ceramic green sheet, but it is preferable to use a printing method. The following describes the formation of the internal electrode pattern using a printing method.

A conductive paste for forming internal electrodes is made by mixing conductive materials and binders. There are no limitations on the conductive material, and at least one metal material selected from the group consisting of nickel (Ni), copper (Cu), palladium (Pd), platinum (Pt), silver (Ag), gold (Au), and alloys of these metals is used, with Ni and Cu being particularly preferred. In addition, conductive paste for forming internal electrodes may contain a powder with a composition similar to that of the ceramic, which is the main component of the ceramic green sheet, in order to increase the adhesion strength of the internal electrode to the dielectric layer of the laminate after firing. In this case, the composition of the ceramic powder may differ slightly from that of the ceramic, which is the main component of the ceramic green sheet, but it is preferable to use the same composition in order to increase the adhesion strength with the dielectric layer. The binder and solvent used should be selected as appropriate so that the ceramic green sheet does not swell during printing.

Next, using the conductive paste for forming internal electrodes described above, an internal electrode pattern is formed on the surface of the ceramic green sheet described above by screen printing, gravure printing, etc. The internal electrode pattern shall have a main body pattern corresponding to the main body portions 131a and 131b of the internal electrodes 13 described above, and a drawer pattern corresponding to the draw-out portions 132a and 132b of said internal electrodes 13.

### Laminating and Pressure Bonding

The ceramic green sheets with the internal electrode patterns described above are laminated in a predetermined number so that the main body patterns overlap in all layers and the drawer patterns overlap in every other layer when viewed from the stacking direction. Then, a ceramic green sheet without an internal electrode pattern is laminated on the top and/or bottom surface of the stacking direction so as to cover the internal electrode pattern.

If the ceramic green sheet with the internal electrode pattern on the top or bottom surface of the laminate is sufficient to protect the laminate, it is sufficient to laminate the ceramic green sheet without the internal electrode pattern on either the top or bottom surface of the laminate.

Next, the above-mentioned stacked ceramic green sheets are pressed together to form a laminated sheet. The pressing process allows the resulting laminated sheet to be made more dense.

### Cutting

The integrated laminated sheet is cut to the predetermined chip dimensions using a push-cutting blade or rotary blade, etc., so that a surface is formed in which all of the edges of the drawer patterns are exposed, to obtain green laminated chips.

### Forming Base Electrodes and a Ceramic Layer

In the method for manufacturing multilayer ceramic capacitors related to the second aspect, nickel base layers are formed on the draw-out surface of the green laminated chip, where all the edges of the drawer patterns are exposed, as necessary, and then base electrodes 21 and a ceramic layer 16 that is in contact with the entire circumference of the base electrodes are formed using ceramic green sheets.

The following describes the method for forming the base electrodes and ceramic layer of the first embodiment described above, as well as the nickel base layers, base electrodes and a ceramic layer of the second embodiment.

### Forming Base Electrodes and a Ceramic Layer of the First Embodiment

In the first embodiment, base electrodes and a ceramic layer are formed on the draw-out surface of the green laminated chip by performing one of the following operations (D-1) to (D-3), so that the base electrodes electrically connect the edges of the internal electrodes' drawer pattern exposed on the draw-out surface every other layer and the ceramic layer contacts with the entire circumference of the base electrodes when viewed from the draw-out surface side.

### Operation (D-1)

In the operation of (D-1), a ceramic green sheet is used that has an opening filled with nickel-containing paste whose shape corresponds to the plane shape of the base electrode in planer view and penetrates in the thickness direction, and the ceramic green sheet is punched out with the draw-out surface of the green laminated chip, and after the ceramic green sheet is attached to the draw-out surface, it is fired.

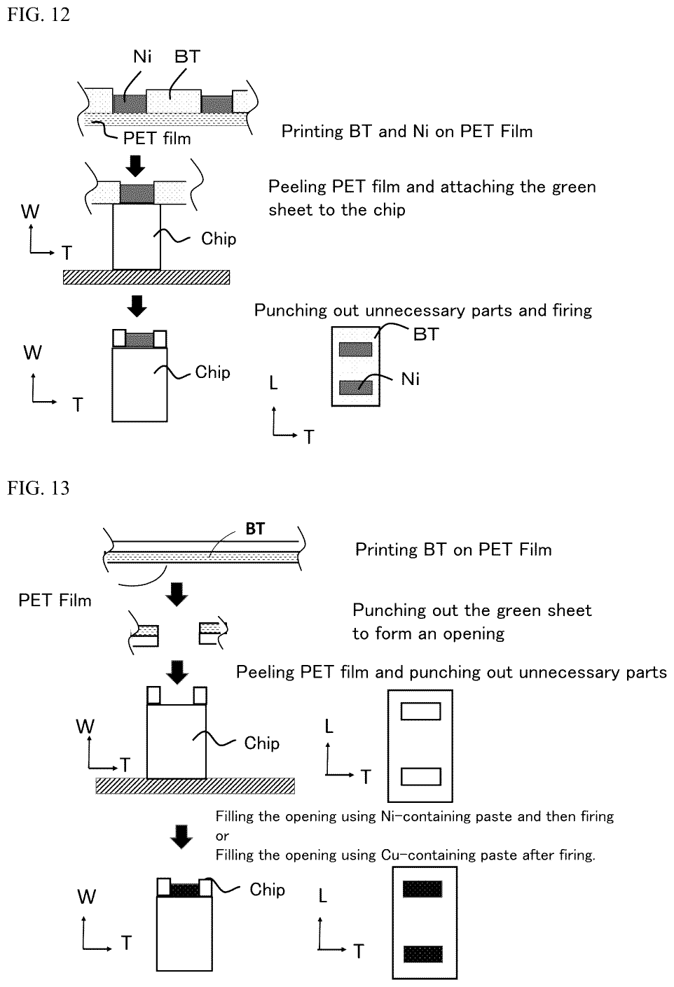

FIG. 12 is a schematic view showing an example of the operation in (D-1).

In the operation shown in FIG. 12, a nickel-containing paste prepared by adding glass components, an organic binder and an organic solvent to nickel powder is used to form the base electrode 21, and a ceramic slurry prepared by adding a binder and an organic solvent to ceramic raw material powder is used to form the ceramic layer 16.

The ceramic slurry and nickel-containing paste are coated or printed onto a base sheet such as PET film to form a ceramic green sheet in which the nickel-containing paste fills the opening that penetrate in the thickness direction. After that, the base sheet is peeled off, and the nickel-containing areas and the ceramics green sheet area are formed simultaneously on the surface of the green laminated chip where the internal electrode is exposed, using the punching method, and then fired. It is noted that FIG. 12 shows an example in which the depth of filling of the nickel-containing paste into the opening of the ceramic green sheet is shallower than the depth of the opening, but the depth of filling of the nickel-containing paste may be the same as the depth of the opening, i.e., it may be formed flush with the ceramic green sheet.

### Operation (D-2) and (D-3)

In the operation of (D-2), a ceramic green sheet having an opening with a shape corresponding to the planar shape of the base electrode in planar view and penetrating in the thickness direction is used, and the ceramic green sheet is punched out with the draw-out surface of the green laminated chip, and after the ceramic green sheet is attached to the draw-out surface, nickel-containing paste is filled into the opening and fired.

According to this operation, by using nickel as the conductive material to form the base electrode 21, the base electrode 21 and the ceramic layer 16 can be formed simultaneously.

In the operation of (D-3), a ceramic green sheet having an opening with a shape corresponding to the planar shape of the base electrode in planar view and penetrating in the thickness direction is used, and the ceramic green sheet is punched out with the draw-out surface of the green laminated chip, and after the ceramic green sheet is attached to the draw-out surface, it is fired, and then the copper-containing paste is filled into the opening and baked.

This is the process when Cu is used as the conductive material to form the base electrode 21. Since it is not possible to form the base electrode 21 and the ceramic layer 16 at the same time, the ceramic layer 16 and the base electrode 21 are formed in this order.

FIG. 13 is a schematic view showing an example of the operations in (D-2) and (D-3).

Operation (D-2) is applied when using nickel as the base electrode 21. As shown in FIG. 13, a ceramic slurry that will form the ceramic layer 16 is coated or printed on the base sheet to form a ceramic green sheet, and an opening corresponding to the planar shape of the base electrode 21 in planar view and penetrating in the thickness direction is formed. After that, the base sheet is peeled off, and the ceramic green sheet is attached to the draw-out surface of the green laminated chip using the punching method. Next, the base electrode material (nickel-containing paste) is filled into the opening and then fired.

Operation (D-3) is applied when using copper as the base electrode 21. As shown in FIG. 13, a ceramic slurry that will form the ceramic layer 16 is coated or printed on the base sheet to form a ceramic green sheet, and an opening corresponding to the planar shape of the base electrode 21 in planar view and penetrating in the thickness direction is formed. After that, the base sheet is peeled off, and the ceramic green sheet is attached to the draw-out surface of the green laminated chip using the punching method. Next, the green laminated chip with the ceramic green sheet is fired. Next, the copper-containing paste, which is the raw material for the base electrode, is filled into the opening, and then baked. It is noted that FIG. 13 shows an example in which the depth of filling of the nickel-containing paste or copper-containing paste into the opening formed by attaching the ceramic green sheet to the green laminated chip is shallower than the depth of the opening, but the depth of filling of the nickel-containing paste or the copper-containing paste may be the same as the depth of the opening, i.e., they may be formed flush with the ceramic green sheet.

### Forming Nickel Base Layers, Base Electrodes and a Ceramic Layer of the Second Embodiment

In the second embodiment, a pair of nickel base layers that are electrically connected to every other layer at the ends of the drawer patterns exposed on the draw-out surface, a pair of base electrodes that are electrically connected to the nickel base layers, and a ceramic layer arranged to be in contact with entire circumference of the base electrodes when viewed from the side are formed on the draw-out surface of the resulting green laminated chip by performing operation (D-4) and (D-5).

### Operation (D-4)

In the operation of (D-4), a pair of nickel-containing layers that is the raw material for the nickel base layers are formed on the draw-out surface where the edges of the drawer patterns are exposed, so that they cover the exposed edges of the drawer patterns by performing one of following operations (D-4-1) to (D-4-3).

In the operation of (D-4-1), a ceramic green sheet is used that has an alternating pattern of a ceramic green sheet area and a nickel-containing area with a shape corresponding to the shape of the nickel base layer formed with nickel-containing paste, and the ceramic green sheet is punched out with the draw-out surface of the green laminated chip and the ceramic green sheet is attached to the draw-out surface.

This operation is similar to the operation described in (D-1) above, and the operation in (D-4-1) corresponds to the operation in the example illustrated in the above FIG. 12, in which nickel-containing paste, which is the raw material for the nickel base layer 24, is used to fill the opening in the ceramic green sheet to a depth equivalent to the depth of the opening.

In the operation of (D-4-2), a ceramic green sheet having an opening with a shape corresponding to the planar shape of the nickel base layer in planar view and penetrating in the thickness direction is used, and the ceramic green sheet is punched out with the draw-out surface of the green laminated chip, and after the ceramic green sheet being attached to the draw-out surface, nickel-containing paste is filled into the opening to form a nickel-containing layer.

This operation is similar to the operation described in (D-2) above, and the operation in (D-4-2) corresponds to the operation in the example illustrated in the above FIG. 13, in which nickel-containing paste, which is the raw material for the nickel base layer 24, is used to fill the opening to a depth equivalent to the depth of the opening.

In the operation (D-4-3), a nickel-containing layer is formed by sputtering deposition, vapor deposition, or printing.

### Operation (D-5)

In the operation of (D-5), the base electrode arranged in the entire area, a part of the area, or multiple areas of the obtained nickel-containing layer, as well as the ceramic layer arranged in contact with the entire circumference of the base electrode when viewed from the draw-out surface side, are formed by performing one of following operations (D-5-1) to (D-5-3). The base electrode formed by this operation is electrically connected to the internal electrode via the nickel base layer, which is formed by sintering the nickel-containing layer. For this reason, in the second embodiment, unlike the first embodiment, the shape and area of the above-mentioned base electrode and the plating layer formed on the base electrode by the operation described below can be made different from the area where the internal electrode is exposed on the draw-out surface side, as viewed from the draw-out surface side.

In the operation of (D-5-1), a ceramic green sheet is used that has an opening filled with nickel-containing paste whose shape corresponds to the plane shape of the base electrode in planer view and penetrates in the thickness direction, and the ceramic green sheet is punched out with the draw-out surface of the green laminated chip, and after the ceramic green sheet is attached to the draw-out surface on which the nickel-containing layer is formed, it is fired.

This operation is similar to the operation described in (D-1) above, and is explained using the example shown in FIG, 12 above.

In the operation of (D-5-2), a ceramic green sheet having an opening with a shape corresponding to the planar shape of the base electrode in planar view and penetrating in the thickness direction is used, and the ceramic green sheet is punched out with the draw-out surface of the green laminated chip, and after the ceramic green sheet is attached to the draw-out surface on which the nickel-containing layer is formed, nickel-containing paste is filled into the opening and fired.

This operation is similar to the operation described in (D-2) above, and is explained in the example of filling the opening in the ceramic green sheet with nickel-containing paste in the above FIG. 13.

In the operation of (D-5-3), a ceramic green sheet having an opening with a shape corresponding to the planar shape of the base electrode in planar view and penetrating in the thickness direction is used, and the ceramic green sheet is punched out with the draw-out surface of the green laminated chip, and after the ceramic green sheet is attached to the draw-out surface on which the nickel-containing layer is formed, it is fired, and then the copper-containing paste is filled into the opening and baked.

This operation is similar to the operation described in (D-3) above, and is explained in the example of filling the opening with Cu-containing paste after firing the green laminated chip in the above FIG. 13.

### Formation of the Plating Layer

In the manufacturing method for multilayer ceramic capacitors related to the second aspect, a plating layer is formed on the formed base electrodes to finish the external electrode, and a multilayer ceramic capacitor is obtained. As shown in FIG. 12 and FIG. 13, when the filling depth of the nickel-containing or copper-containing paste used to form the base electrode is shallower than the depth of the opening, the short-circuit between the external electrodes is suppressed. This is thought to be due to the base electrode being formed in a concave shape relative to the base ceramic layer, which suppresses the spread of the plating layer in the direction of the draw-out surface, particularly in the direction of L in FIG. 1.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multilayer ceramic capacitor comprising:
a ceramic element body that has a laminate with a roughly rectangular parallelepiped shape and comprising multiple internal electrodes facing each other in the stacking direction and a dielectric layer arranged between the multiple internal electrodes,
a pair of external electrodes arranged in connection with the ends of draw-out portions of the internal electrodes on a draw-out surface of the ceramic element body where the internal electrodes are drawn out, and
a ceramic layer arranged in contact with the entire circumference of the external electrodes when viewed from the draw-out surface side.

2. The multilayer ceramic capacitor according to claim 1, wherein each of the external electrode comprises a base electrode electrically connecting the ends of draw-out portions of the internal electrodes, and a plating layer formed on the surface of the base electrode.

3. The multilayer ceramic capacitor according to claim 2, wherein the base electrode is a metal layer containing copper as a main component, and the plating layer is formed in the order of a nickel plating layer and a tin plating layer.

4. The multilayer ceramic capacitor according to claim 2, wherein the base electrode is a metal layer containing nickel as a main component, and the plating layer is formed in the order of a copper plating layer, a nickel plating layer, and a tin plating layer.

5. The multilayer ceramic capacitor according to claim 1, wherein each of the external electrode comprises nickel base layer electrically connected to the ends of the draw-out portions of the internal electrodes, base electrode formed to be electrically connected to the nickel base layer, and a plating layer formed on the base electrode.

6. The multilayer ceramic capacitor according to claim 5, wherein the nickel base layer is a nickel thin film layer.

7. The multilayer ceramic capacitor according to claim 5, wherein the base electrode is formed on the entire surface of the plane that is perpendicular to the stacking direction of the external electrode in the nickel base layer.

8. The multilayer ceramic capacitor according to claim 5, wherein the base electrode is formed on a part of the plane that is perpendicular to the stacking direction of the external electrode in the nickel base layer.

9. The multilayer ceramic capacitor according to claim 5, wherein the base electrode is formed in multiple areas of a plane that is perpendicular to the stacking direction of the external electrode in the nickel base layer.

10. The multilayer ceramic capacitor according to claim 8, wherein the base electrode is formed in a position that does not overlap with the area where the internal electrodes are drawn out when viewed from the stacking direction of the external electrode.

11. The multilayer ceramic capacitor according to claim 9, wherein the base electrode is formed in a position that does not overlap with the area where the internal electrodes are drawn out when viewed from the stacking direction of the external electrode.

12. The multilayer ceramic capacitor according to claim 8, wherein the surfaces of the aforementioned pair of external electrodes are shaped such that the distance between them is greater at the center of the stacking direction of the laminate than at the both ends of the stacking direction of the laminate.

13. The multilayer ceramic capacitor according to claim 9, wherein the surfaces of the aforementioned pair of external electrodes are shaped such that the distance between them is greater at the center of the stacking direction of the laminate than at the both ends of the stacking direction of the laminate.

14. The multilayer ceramic capacitor according to claim 5, wherein the base electrode is a sintered metal layer containing nickel or copper, and the plating layer is formed in the order of nickel plating layer and tin plating layer.

15. A method for manufacturing a multilayer ceramic capacitor comprising:
(A) laminating a predetermined number of ceramic green sheets with internal electrode patterns, which have a main body pattern and a drawer pattern that extends in one direction from the main body pattern, so that the main body pattern overlaps all layers and the drawer pattern overlaps every other layer when viewed from the stacking direction, and then laminating a ceramic green sheet without an internal electrode pattern to the top and/or bottom surface of the stacking direction, covering the internal electrode pattern,
(B) pressing the ceramic green sheets together to make a laminated sheet,
(C) cutting the laminated sheet to the predetermined dimensions to obtain a green laminated chip with a draw-out surface that exposes all of the edges of the drawer pattern,
(D) by performing one of following operations (D-1) to (D-3), forming a pair of base electrodes that are electrically connected every other layer at the end of the drawer pattern exposed on the draw-out surface and a ceramic layer arranged to be in contact with entire circumference of the base electrodes when viewed from the draw-out surface side of the resulting green laminated chip,
(D-1) preparing a ceramic green sheet having an opening filled with nickel-containing paste whose shape corresponds to the planar shape of the base electrode in planar view and penetrates in the thickness direction, punching out the ceramic green sheet at the draw-out surface of the green laminated chip, and attaching the ceramic green sheet to the draw-out surface, and then firing,
(D-2) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface, filling nickel-containing paste into the opening, and then firing,
(D-3) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface, firing the green laminated chip, and then filling copper-containing paste into the opening and baking, and
(E) forming a plating layer on the base electrode.

16. A method for manufacturing a multilayer ceramic capacitor comprising:
(A) laminating a predetermined number of ceramic green sheets with internal electrode patterns, which have a main body pattern and a drawer pattern that extends in one direction from the main body pattern, so that the main body pattern overlaps all layers and the drawer pattern overlaps every other layer when viewed from the stacking direction, and then laminating a ceramic green sheet without an internal electrode pattern to the top and/or bottom surface of the stacking direction, covering the internal electrode pattern,
(B) pressing the ceramic green sheets together to make a laminated sheet,
(C) cutting the laminated sheet to the predetermined dimensions to obtain a green laminated chip with a draw-out surface that exposes all of the edges of the drawer pattern,
(D)′ by performing following operations (D-4) and (D-5), forming a pair of nickel base layers that are electrically connected to every other layer at the end of the drawer pattern exposed on the draw-out surface, a pair of base electrodes that are electrically connected to the nickel base layers, and a ceramic layer arranged to be in contact with entire circumference of the base electrodes when viewed from the draw-out surface side of the resulting green laminated chip,
(D-4) by performing one of following operations (D-4-1) to (D-4-3), forming a pair of nickel-containing layers that will become the nickel base layers after firing on the draw-out surface where the edges of the internal electrode patterns are exposed, so that they cover the exposed edges of the internal electrode patterns,
(D-4-1) preparing a ceramic green sheet that alternately has a plurality of nickel-containing areas corresponding to the planar shape of the nickel base layer formed with a nickel-containing paste and a plurality of ceramic green sheet areas, punching out the ceramic green sheet at the draw-out surface of the green laminated chip, and attaching the ceramic green sheet to each end surface,
(D-4-2) preparing a ceramic green sheet having an opening with a shape corresponding to the planar shape of the nickel base layer in planar view and penetrating in the thickness direction, punching out the ceramic green sheet at the draw-out surface of the green laminated chip, and after the ceramic green sheet being attached to the draw-out surface, filling nickel-containing paste into the opening to form a nickel-containing layer,
(D-4-3) forming nickel-containing layers by sputtering deposition, vapor deposition, or printing,
(D-5) by performing one of the following operations (C-5-1) to (C-5-3), forming a pair of base electrodes in all, a part of, or multiple areas of each nickel-containing layer,
(D-5-1) preparing a ceramic green sheet having an opening filled with nickel-containing paste whose shape corresponding to the planar shape of the base electrode in planar view and penetrates in the thickness direction, punching out the ceramic green sheet at the draw-out surface of the green laminated chip, and attaching the ceramic green sheet to the draw-out surface where the nickel-containing layers have formed, and then firing,
(D-5-2) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface where the nickel-containing layers have formed, filling nickel-containing paste into the opening, and then firing,
(D-5-3) preparing a ceramic green sheet having an opening with a shape corresponding to the planar shape of the base electrode in planar view and penetrating in the thickness direction, punching out the ceramic green sheet at the draw-out surface of the green laminated chip, and after the ceramic green sheet being attached to the draw-out surface where the nickel-containing layers have formed, firing the green laminated chip, and then filling copper-containing paste into the opening and baking, and
(E) forming a plating layer on the base electrode.
